(19) United States
(12) Patent Application Publication
(10) Pub. No.: US 2013/0078470 A1
(43) Pub. Date: Mar. 28, 2013

(54) FIXING BELT, METHOD OF MANUFACTURING FIXING BELT, FIXING DEVICE, AND IMAGE FORMING APPARATUS

(71) Applicants: Hisashi MURASE, Kanagawa (JP); Hitoshi OKAZAKI, Kanagawa (JP)

(72) Inventors: Hisashi MURASE, Kanagawa (JP); Hitoshi OKAZAKI, Kanagawa (JP)

(73) Assignee: FUJI XEROX CO., LTD., TOKYO (JP)

(21) Appl. No.: 13/412,123

(22) Filed: Mar. 5, 2012

(30) Foreign Application Priority Data
Sep. 22, 2011 (JP) 2011-207086

(51) Int. Cl. B32B 9/04; G03G 15/20

(52) U.S. Cl. 428/411.1; 399/333

(57) ABSTRACT

A fixing belt includes a base layer that contains a resin, a flat metal heat-generating layer that is provided on the base layer and contains metal as a main component, and a protective layer that is provided on the metal heat-generating layer and contains a resin, wherein the metal heat-generating layer contains resin portions that pass through the metal heat-generating layer in a thickness direction of the layer, and the resin portions contain at least one of the resin of the base layer and the resin of the protective layer.

### CROSS-REFERENCE TO RELATED APPLICATIONS

This application is based on and claims priority under 35 USC 119 from Japanese Patent Application No. 2011-207086 filed Sep. 22, 2011.

### BACKGROUND

(i) Technical Field

The present invention relates to a fixing belt, a method of manufacturing the fixing belt, a fixing device, and an image forming apparatus.

(ii) Related Art

In the past, in an image forming apparatus, such as an electrophotographic copy machine or printer, unfixed toner images, which are formed on a recording medium such as a sheet, are fixed by a fixing device, so that an image is formed. In the past, a pressure fixing method, an oven fixing method, a solvent fixing method, and the like have been known in the fixing step. However, a heat-pressure fixing method is most generally used in terms of effective transfer of heat, the more solid fixing of a toner image, and relative safety. This heat-pressure fixing method is a method of fixing a toner image to a recording medium by making the recording medium on which unfixed toner images are supported pass through a nip formed by a fixing member, such as a heated fixing roll or a heated fixing belt, and pressing the unfixed toner images, which are heated and melted by the fixing roll or the fixing belt, against the recording medium by nip pressure when the recording medium passes through the nip.

In recent years, an electromagnetic induction heating method has been examined as a method of heating the fixing member. If this electromagnetic induction heating method is used, the surface of the fixing member to be heated is effectively heated with high thermal efficiency. Accordingly, the time taken until an image can be fixed (which may be referred to as “warm-up time” hereinafter) is shortened.

Examples of the fixing member, which is applied to this electromagnetic induction heating method, include an endless fixing belt having a structure where a metal heat-generating layer is formed on a base material containing a heat-resistant resin such as engineering plastics. The strength of the fixing belt having this structure is secured by the base material containing a heat-resistant resin. Accordingly, as long as heat-generating performance is sufficiently kept, it is possible to reduce the thickness of the metal heat-generating layer. Therefore, it is possible to shorten warm-up time. Further, since the base material contains a heat-resistant resin, the slidability between the base material and the pressing member that is provided on the inner surface of the fixing belt is excellent.

Since the fixing belt is bent at a large curvature in the image forming apparatus or the fixing device where the endless fixing belt is used, a recording medium, which is sent between the fixing belt and the pressure member pressed against the fixing belt, is discharged in a direction, where the recording medium is separated from the fixing belt, due to its own rigidity. Accordingly, the recording medium is easily separated from the endless belt.

There is examined the improvement of the durability of the endless fixing belt against bending deformation or the like.

### SUMMARY

According to an aspect of the invention, there is provided a fixing belt including a base layer that contains a resin, a flat metal heat-generating layer that is provided on the base layer and contains metal as a main component, and a protective layer that is provided on the metal heat-generating layer and contains a resin, wherein the metal heat-generating layer contains resin portions that pass through the metal heat-generating layer in a thickness direction of the layer, and the resin portions contain at least one of the resin of the base layer and the resin of the protective layer.

### BRIEF DESCRIPTION OF THE DRAWINGS

Exemplary embodiments of the present invention will be described in detail based on the following figures, wherein:

FIG. 1 is a schematic view showing an example of a fixing belt according to an exemplary embodiment of the invention;

FIG. 2 is a conceptual view of a cross-section taken along a line A-A′ of FIG. 1;

FIG. 3 is a schematic view showing another example of the fixing belt according to the exemplary embodiment of the invention;

FIG. 4 is a view showing an image of the structure of a metal heat-generating layer of Comparative Example 1;

FIG. 5 is a side cross-sectional view showing an example of the structure of a fixing device according to an exemplary embodiment of the invention; and

FIG. 6 is a schematic view showing the structure of an example of an image forming apparatus according to an exemplary embodiment of the invention.

### DETAILED DESCRIPTION

Exemplary embodiments of the invention will be described below. These exemplary embodiments are examples that embody the invention, and the invention is not limited to these exemplary embodiments.

<Fixing Belt>

A fixing belt according to an exemplary embodiment of the invention includes at least three layers and has the structure where a base layer containing a resin, a metal heat-generating layer containing metal as a main component, and a protective layer containing a resin are formed in this order from inside. The metal heat-generating layer contains resin portions that pass through the metal heat-generating layer in a thickness direction, and at least one of the resin of the base layer and the resin of the protective layer forms the resin portions. Accordingly, heat-generating performance caused by the metal heat-generating layer is kept, excellent bendability is obtained against bending deformation or the like, and the number of origins of cracks or the like of the metal heat-generating layer is reduced. Therefore, high durability is obtained against bending deformation or the like. In particular, high durability is obtained against temperature rise in a short time or bending deformation repeated during use.

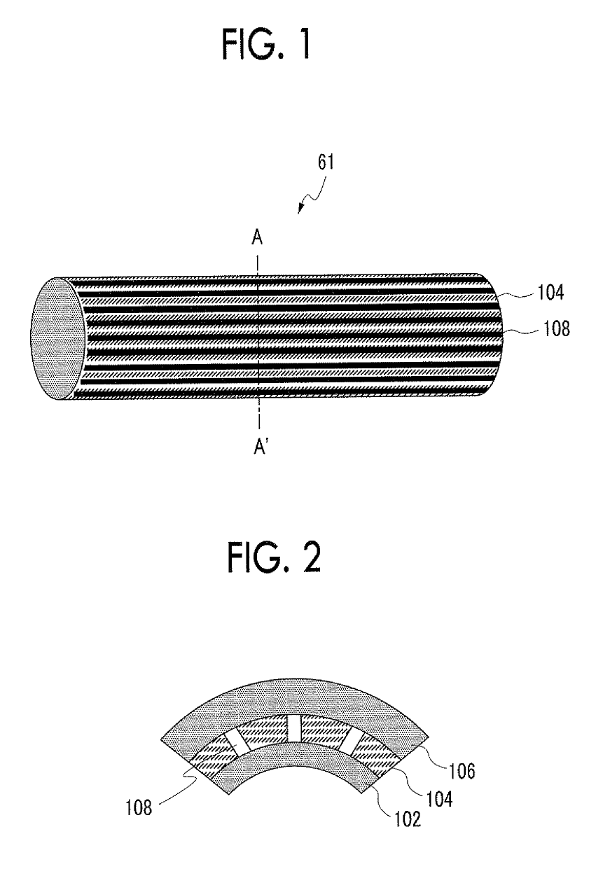

FIG. 1 is a schematic view showing an example of a fixing belt according to an exemplary embodiment of the invention. Further, FIG. 2 shows a conceptual view of a cross-section taken along a line A-A′ of FIG. 1. As shown in FIG. 2, a fixing belt 61 includes at least three layers, and has a structure where a base layer 102 containing a resin, a metal heat-generating layer 104 containing metal as a main component, and a protective layer 106 containing a resin are formed in this order from inside. Meanwhile, the protective layer 106 is not shown in FIG. 1. As shown in FIG. 2, the metal heat-generating layer 104 contains resin portions 108 that pass through the metal heat-generating layer in a thickness direction, and at least one of the resin of the base layer 102 and the resin of the protective layer 106 forms the resin portions 108. Further, the protective layer 106 and the base layer 102 adhere to each other through the resin portions 108. In the example of FIG. 1, the straight resin portions 108 are present at the metal heat-generating layer 104 at a regular pitch in the circumferential direction of the fixing belt 61 over the width direction of the belt (over the entire width of the belt in the example of FIG. 1). Due to this structure of the caterpillar-shape metal heat-generating layer, heat-generating performance caused by the metal heat-generating layer is secured, excellent bendability is obtained against bending deformation or the like, and the number of origins of cracks or the like of the metal heat-generating layer is reduced.

The base layer 102 contains a resin, and it is preferable that the base layer 102 contain a resin as a main component. The mass ratio of the main component is 50% or more. The resin of the base layer 102 forms the resin portions 108 of the metal heat-generating layer 104, and may have a function of adhering to the protective layer 106. Examples of the resin include one resin or the mixture of plural resins selected from, for example, a thermosetting polyimide resin, a thermoplastic polyimide resin, a polyamide resin, a polyamide-imide resin, a polybenzimidazole resin, and the like. A polyimide resin is preferable in terms of heat resistance, mechanical characteristics, and the like.

The thickness of the base layer 102 is in the range of, for example, 10 μm to 200 μm. If the thickness of the base layer 102 exceeds 200 μm, flexibility may not be secured or warm-up time may be lengthened due to the increase of heat capacity. On the other hand, if the thickness of the base layer 102 is smaller than 10 μm, rigidity is small and wrinkles may be formed at the base layer or cracks may be formed at both ends of the base layer.

The metal heat-generating layer 104 is a layer that has a function of generating heat by generating eddy current by a magnetic field generated from coils in an electromagnetic induction heating type fixing device. The metal heat-generating layer 104 contains metal that causes an electromagnetic induction action. The metal, which causes an electromagnetic induction action, is selected from, for example, single metals, such as nickel, iron, copper, gold, silver, aluminum, chrome, tin, and zinc, and alloys (steel and the like) made of two or more kinds of elements. Silver or copper is preferable in terms of workability to a thin film, heat-generating performance, and the like. Silver is more preferable in terms of oxidation resistance and the like.

The appropriate thickness of the metal heat-generating layer 104 varies according to the material thereof. However, when, for example, silver is used for the metal heat-generating layer, it is preferable that the thickness of the metal heat-generating layer be in the range of 3 μm to 30 μm. If the thickness of the metal heat-generating layer 104 is smaller than 3 μm, the resistance value of the metal heat-generating layer is increased. For this reason, sufficient eddy current is not easily generated, so that generated heat is insufficient. As a result, warm-up time may be lengthened or the metal heat-generating layer may not be sufficiently heated up to a fixable temperature. Further, if the thickness of the metal heat-generating layer 104 exceeds 30 μm, sufficient generated heat can be obtained but the heat capacity of the layer itself is increased. For this reason, warm-up time may be lengthened.

The interval (pitch) of the resin portions 108 in the circumferential direction of the belt is preferably in the range of, for example, 0.1 mm to 10 mm, and more preferably in the range of 0.5 mm to 7 mm. If the interval of the resin portions 108 in the circumferential direction of the belt exceeds 7 mm, the metal heat-generating layer itself is repeatedly subjected to sudden bending deformation, so that cracks may be formed. If the interval of the resin portions 108 in the circumferential direction of the belt is smaller than 0.1 mm, the area of the metal heat-generating layer is reduced, so that heat-generating performance may deteriorate. The resin portions 108 are disposed at regular intervals in the circumferential direction of the belt.

It is preferable that the interval of the resin portions 108 in the circumferential direction of the belt be equal to or smaller than a nip width. If the interval of the resin portions is equal to or smaller than a nip width, a property following bending deformation or the like is excellent and durability is high. Here, the nip width means the width of a portion of the fixing belt 61, which comes into contact with a pressure member such as a pressure roll, in the transport direction of a recording medium when a load is applied.

The width of the resin portion 108 is preferably in the range of, for example, 1 μm to 1000 μm, and more preferably in the range of 5 μm to 500 μm. If the width of the resin portion 108 exceeds 500 μm, the continuous area of non-heat generating portions is increased, so that toner may not be fixed. If the width of the resin portion 108 is smaller than 5 μm, bendability against bending deformation or the like may not be sufficient.

The shape of the resin portion 108 is not particularly limited but is, for example, a curved shape or the like other than a straight shape.

The protective layer 106 contains a resin, and it is preferable that the protective layer 106 contain a resin as a main component. The resin of the protective layer 106 forms the resin portions 108 of the metal heat-generating layer 104, and may have a function of adhering to the base layer 102. Examples of the resin include one resin or the mixture of plural resins selected from, for example, a thermosetting polyimide resin, a thermoplastic polyimide resin, a polyamide resin, a polyamide-imide resin, a polybenzimidazole resin, and the like. A polyimide resin is preferable in terms of heat resistance, mechanical characteristics, and the like. In terms of adhesiveness and the like, it is preferable that the base layer 102 and the protective layer 106 be made of a resin, which has the same components, as a main component.

The thickness of the protective layer 106 is in the range of, for example, 50 μm to 200 μm. If the thickness of the protective layer 106 is 50 μm or more, it is possible to keep rigidity required for the belt. Further, if the thickness of the protective layer 106 is 200 μm or less, warm-up time is shortened.

The fixing belt 61 may further include an elastic layer, a release layer, and the like on the outer peripheral surface of the protective layer.

Examples of a material of the elastic layer include rubber, such as silicone rubber and fluorine rubber. The thickness of the elastic layer is in the range of, for example, 0.1 mm to 3 mm.

The release layer is to suppress the fixing of molten toner to a fixing member when unfixed toner images are to be fixed to a recording medium while being melted. As long as the release layer has appropriate releasability with respect to the toner image, any material may be used as a material of the release layer and the material of the release layer is not particularly limited. It is preferable that the release layer be made of a fluorine-based compound as a main component. Examples of the fluorine-based compound include fluorine resins, such as fluorine rubber, polytetrafluoroethylene (PTFE), a perfluoroalkyl vinyl ether copolymer (PFA), and fluorinated ethylene propylene copolymer (FEP).

The thickness of the release layer is in the range of, for example, 10 μm to 100 μm. If the thickness of the release layer is 10 μm or more, the abrasion of the release layer, which is caused by the repeated friction or the like between the release layer and the edge of a sheet used as a recording medium, is easily suppressed. Meanwhile, if the thickness of the release layer is 100 μm or less, the flexibility of the surface of the belt is easily kept. As a result, a force pressing toner is suppressed and the granularity of the fixed image is maintained, so that warm-up time is shortened.

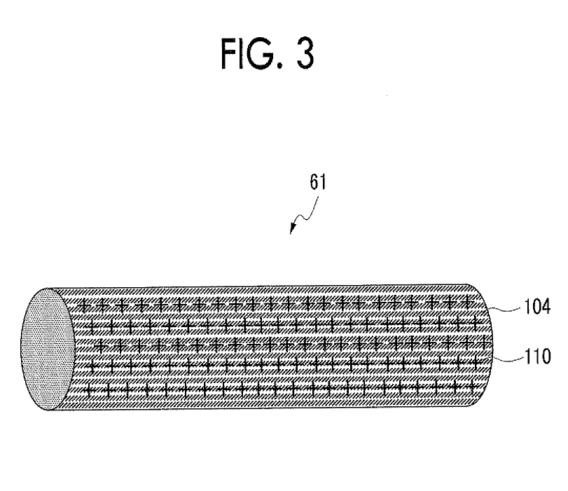

FIG. 3 is a schematic view showing another example of the fixing belt according to the exemplary embodiment of the invention. Meanwhile, the protective layer 106 is not shown in FIG. 3. The metal heat-generating layer 104 contains resin portions 110 that pass through the metal heat-generating layer in a thickness direction. Further, although not shown, at least one of the resin of the base layer 102 and the resin of the protective layer 106 forms the resin portions 110 and the protective layer 106 and the base layer 102 adhere to each other through the resin portions 110. In the example of FIG. 3, the cross-shaped resin portions 110 are scattered at the metal heat-generating layer 104 on the surface of the belt (the entire surface of the belt in the example of FIG. 3). Due to this structure of the metal heat-generating layer, heat-generating performance caused by the metal heat-generating layer is secured, excellent bendability is obtained against bending deformation or the like, and the number of origins of cracks or the like of the metal heat-generating layer is reduced.

The interval of the resin portions 110 in the circumferential direction is preferably in the range of, for example, 0.05 mm to the nip width, and more preferably in the range of 0.1 mm to the nip width. If the interval of the resin portions 110 in the circumferential direction exceeds the nip width, cracks may be formed at the heat-generating layer during repeated use of the heat-generating layer. If the interval of the resin portions 110 in the circumferential direction is smaller than 0.05 mm, the metal heat-generating layer may not keep sufficient heat-generating performance. The resin portions 110 may be disposed at regular intervals in the circumferential direction of the belt.

It is preferable that the interval of the resin portions 110 in an axial direction be, for example, 0.05 mm or more. If the interval of the resin portions 110 in the axial direction is smaller than 0.05 mm, the metal heat-generating layer may not keep sufficient heat-generating performance.

The shape of the resin portion 110 is not particularly limited but is, for example, across shape, an elliptical shape, a straight shape, a curved shape or the like other than a circular shape.

The disposition of the resin portions 110 is not particularly limited. However, for example, the resin portions 110 may be disposed linearly at the above-mentioned intervals in the axial direction and may be disposed at the above-mentioned intervals in the circumferential direction.

It is preferable that the interval of the resin portions 110 in the circumferential direction of the belt be equal to or smaller than the nip width. If the interval of the resin portions is set to be equal to or smaller than the nip width, a property following bending deformation or the like is excellent and durability is high.

<Method of Manufacturing Fixing Belt>

A method of manufacturing the fixing belt according to an exemplary embodiment of the invention includes, for example, a metal heat-generating layer forming step of forming the metal heat-generating layer 104 on the base layer 102 and a protective layer forming step of forming the protective layer 106. Further, the method may include a baking step of simultaneously baking the base layer 102, the metal heat-generating layer 104, and the protective layer 106.

In the metal heat-generating layer forming step, the metal heat-generating layer 104 is formed on the base layer 102. For example, a method that includes applying metal paste such as silver paste, which contains a silver compound, a resin, a solvent, and the like, to, for example, a semidry film of the base layer 102; drying the metal paste; and baking the metal paste by heating may be used as a method of forming the metal heat-generating layer 104. Other than this method, a method of forming a film by plating or the like may be used as the method of forming the metal heat-generating layer 104.

The metal heat-generating layer forming step includes a opening portion forming step of forming opening portions at the metal heat-generating layer. Examples of a method of forming the opening portions at the metal heat-generating layer include a screen printing method, a photolithographic method, a method of forming openings by controlling temperature at the time of the formation of the metal heat-generating layer. The metal heat-generating layer having the structure of FIG. 1 may be formed in the shape of a predetermined pattern by, for example, a screen printing method among these methods. Further, the metal heat-generating layer having the structure of FIG. 3 may be formed by forming opening portions with a method of heating the metal heat-generating layer.

Examples of a method of forming the protective layer 106 in the protective layer forming step include a method of applying a resin solution such as a polyimide precursor solution and baking the resin solution.

In the baking step, the base layer 102, the metal heat-generating layer 104, and the protective layer 106 are simultaneously baked and the base layer and the polyimide precursor of the protective layer are cross-linked. Accordingly, adhesiveness between the base layer 102 and the protective layer 106 through the opening portion becomes excellent and manufacturing steps are simplified.

The elastic layer, the release layer, and the like may be formed by a known method.

<Fixing Device>

Next, the structure of a fixing device according to this exemplary embodiment will be described. The fixing device according to this exemplary embodiment includes the fixing belt. Meanwhile, if an electromagnetic induction heating type fixing device is used as the fixing device according to this exemplary embodiment, the surface of a fixing member to be heated is effectively heated with high thermal efficiency. Accordingly, warm-up time is shortened.

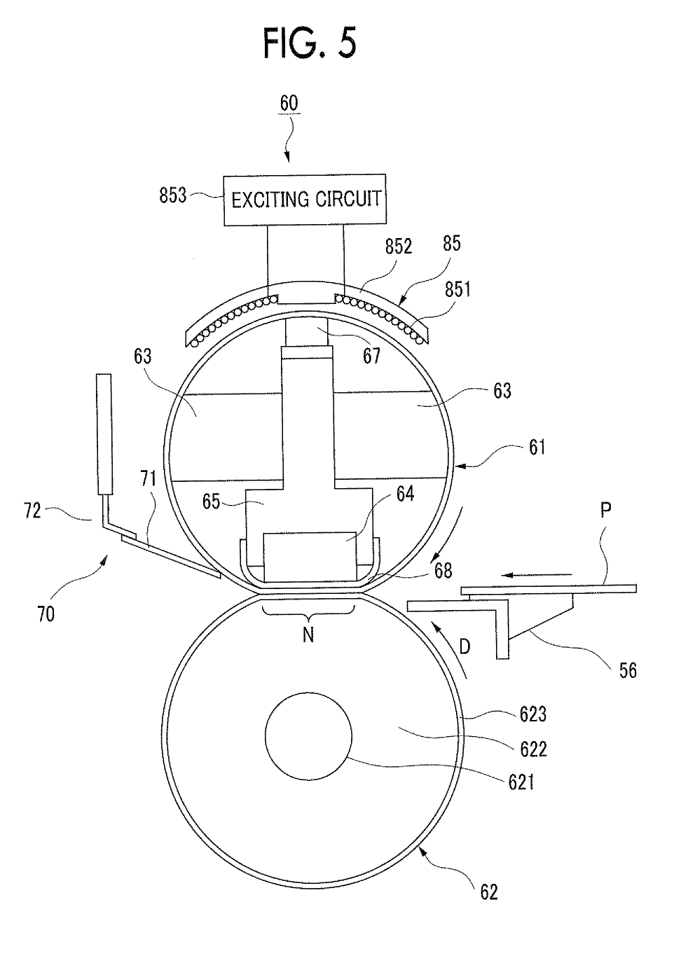

As shown in FIG. 5, the fixing device 60 according to this exemplary embodiment includes a pressure roll 62 that is a rotatable rotating member, a rotatable fixing belt 61, and a sliding sheet 68. The rotatable fixing belt 61 is disposed so as to contact the pressure roll 62, which is a rotating member, and makes a recording medium P, which forms unfixed toner images, be nipped at a pressure portion N (hereinafter, referred to as a “nip portion N”) formed between the pressure roll 62 and the rotatable fixing belt 61 so as to fix the unfixed toner images to the recording medium P. The sliding sheet 68 is interposed between the fixing belt 61 and a pressing pad 64 that is a pressing member. As described above, the fixing belt 61 includes at least three layers and has the structure where the base layer containing a resin, the metal heat-generating layer containing metal as a main component, and the protective layer containing a resin are formed in this order from inside. The metal heat-generating layer contains the resin portions that pass through the metal heat-generating layer in the thickness direction, and the protective layer forms the resin portions. Meanwhile, the sliding sheet 68 will be described below.

The fixing device 60 includes the fixing belt 61, a magnetic field generating unit 85 as an example of a heating member that makes the fixing belt 61 generate heat by a magnetic field generated by alternating current, a pressure roll 62 as an example of a pressure member that is disposed so as to face the fixing belt 61, and a pressing pad 64 that is pressed from the pressure roll 62, which is a rotating member, with the fixing belt 61 interposed therebetween.

The fixing belt 61 is supported by the pressing pad 64, belt guide members 63, and edge guide members (not shown), which are disposed at both end portions of the fixing belt 61, so as to be freely rotationally driven. Further, the fixing belt 61 is urged against the pressure roll 62 at the pressure portion (nip portion) N and is rotationally driven in the direction of an arrow by the pressure roll 62.

The belt guide members 63 are mounted on a holder 65 that is disposed on the inside of the fixing belt 61. Moreover, since the belt guide members 63 are formed of plural ribs (not shown) oriented in the rotational drive direction of the fixing belt 61, the contact area between the inner peripheral surface of the fixing belt 61 and the belt guide members 63 is small. In addition, the belt guide member 63 is made of a heat-resistant resin, such as PFA (perfluoroalkyl vinyl ether copolymer) or PPS (polyphenylene sulfide), which has a low coefficient of friction and low thermal conductivity. Accordingly, the sliding resistance between the belt guide member 63 and the inner peripheral surface of the fixing belt 61 is reduced and the diffusion of heat is reduced.

The pressing pad 64 forms the pressure portion N by being pressed from the pressure roll 62 with the fixing belt 61 interposed therebetween. The pressing pad 64 is supported by the holder 65 so as to press the pressure roll 62 with a load of, for example, 35 kgf by an elastic body such as a spring. The pressing pad 64 is formed of an elastic body such as silicone rubber or fluorine rubber. Concave and convex portions are formed at a portion of the pressing pad 64 facing the pressure roll 62. Accordingly, when the fixing belt 61 is separated from the surface of the pressing pad 64 facing the pressure roll 62, the curvature of the fixing belt is suddenly changed, so that the recording medium P to which the toner image has been fixed is apt to be released from the fixing belt 61.

An auxiliary release member 70, which is provided near the downstream side of the pressure portion N, includes a release baffle 71 that is held by a baffle holder 72 while facing a direction opposite to the rotational direction of the fixing belt 61 (counter direction). Further, a sliding sheet 68 is provided between the pressing pad 64 and the fixing belt 61, so that the sliding resistance between the pressing pad 64 and the inner peripheral surface of the fixing belt 61 is reduced. In this exemplary embodiment, the sliding sheet 68 is formed separately from the pressing pad 64, and both ends of the sliding sheet 68 are fixed to the holder 65.

A lubricant applying member 67 is disposed on the holder 65 over the longitudinal direction of the fixing device 60. The lubricant applying member 67 contacts the inner peripheral surface of the fixing belt 61, and supplies a lubricant to a sliding portion between the fixing belt 61 and the sliding sheet 68. Meanwhile, examples of the lubricant include liquid oil, such as silicone oil and fluorine oil; grease or the like obtained by mixing a solid material to liquid; and the combination thereof.

The pressure roll 62 includes a solid core (columnar core bar) 621 that is made of iron or the like and has a diameter of, for example, 16 mm; a rubber layer 622 that is coated on the outer peripheral surface of the core 621, has a thickness of, for example, 12 mm, and is made of silicone sponge or the like; and a surface layer 623 that has a thickness of, for example, 30 μm and is formed by coating the rubber layer with a heat-resistant resin such as PFA or heat-resistant rubber. Meanwhile, examples of a method of manufacturing the pressure roll 62 include a method of forming the rubber layer 622 by vulcanizing and foaming silicone rubber through a heating treatment (150° C., two hours) after loading a fluorine resin tube, which is formed by applying an adhesive primer to the inner peripheral surface of a PFA tube (forming the surface layer 623), and a solid shaft (forming the core 621) in a mold and injecting liquid foamed silicone rubber to a space between the fluorine resin tube and the solid shaft.

The pressure roll 62 is disposed so as to face the fixing belt 61, and is rotated in the direction of an arrow D at a process speed of, for example, 140 mm/sec, and drives the fixing belt 61. Further, the fixing belt 61 is held while being interposed between the pressure roll 62 and the pressing pad 64, so that the pressure portion N is formed. The recording medium P, which supports unfixed toner images, passes through the pressure portion N and the unfixed toner images are fixed to the recording medium by heat and pressure.

The magnetic field generating unit 85 has a curved cross-section along the shape of the fixing belt 61, and is disposed so as to be distant from the outer peripheral surface of the fixing belt 61 by a distance of, for example, about 0.5 mm to 2 mm. The magnetic field generating unit 85 includes an exciting coil 851 that generates a magnetic field, a coil support member 852 that holds the exciting coil 851, and an exciting circuit 853 that supplies current to the exciting coil 851.

For example, a coil, which is formed by winding a litz wire, which is formed by bundling 16 to 20 copper wire rods insulated from each other and having a diameter of about 0.5 mm, in the shape of a closed ring, such as an oval or elliptical shape or a rectangular shape, is used as the exciting coil 851. When alternating current having a predetermined frequency is supplied to the exciting coil 851 by the exciting circuit 853, an AC magnetic field H is generated around the exciting coil 851. When the AC magnetic field H crosses a metal layer of the fixing belt 61, eddy current I is generated by an electromagnetic induction action so that a magnetic field hindering the change of the AC magnetic field H is generated. The frequency of alternating current supplied to the exciting coil 851 may be set in the range of, for example, 10 kHz to 50 kHz. When eddy current I flows through the metal heat-generating layer of the fixing belt 61, Joule heat caused by electric power W (W=I2R) proportional to a resistance value R of the metal heat-generating layer is generated and the fixing belt 61 is heated.

The coil support member 852 is made of, for example, a non-magnetic material having heat resistance. Examples of the non-magnetic material include heat-resistant resins, such as heat-resistant glass, polycarbonate, polyethersulfone, and PPS, and heat-resistant resins that are formed by mixing glass fiber to these heat-resistant resins.

Meanwhile, the electromagnetic induction heating type fixing device 60, which includes the magnetic field generating unit 85 as an example of a heating member heating the fixing belt 61, has been described in this exemplary embodiment. However, a radiation lamp-heating element or a resistance heating element may be employed as the heating member.

Examples of the radiation lamp-heating element include a halogen lamp. Examples of the resistance heating element include an iron-chrome-aluminum alloy, a nickel-chrome alloy, platinum, molybdenum, tantalum, tungsten, silicon carbide, molybdenum-silicide, and carbon.

In the fixing device 60, the fixing belt 61 is rotated by the rotation of the pressure roll 62 in the direction of an arrow D and is exposed to the magnetic field that is generated by the exciting coil 851. In this case, eddy current is generated in the metal heat-generating layer of the fixing belt 61 and the outer peripheral surface of the fixing belt 61 is heated to a fixable temperature. The fixing belt 61, which is heated in this way, is moved to the pressure portion N between the pressure roll 62 and the fixing belt 61. The recording medium P where unfixed toner images are formed on the surface is carried into the fixing device 60 through a fixing entry guide 56 by a transport unit. When the recording medium P passes through the pressure portion N between the fixing belt 61 and the pressure roll 62, the unfixed toner images are heated by the fixing belt 61 and fixed to the surface of the recording medium P. After that, the recording medium P where the image is formed on the surface is transported by the transport unit and discharged from the fixing device 60. Further, the fixing belt 61, which has finished fixing processing at the pressure portion N and of which the temperature of the outer peripheral surface has fallen, is rotated toward the exciting coil 851 and is heated again for the next fixing processing.

<Image Forming Apparatus>

Next, the structure of an image forming apparatus including the fixing device according to this exemplary embodiment will be described. The image forming apparatus according to this exemplary embodiment includes at least a toner image forming unit that forms unfixed toner images on a recording medium, and the fixing device.

The structure of the image forming apparatus according to this exemplary embodiment will be described below with reference to a drawing, but the invention is not limited to the following exemplary embodiment.

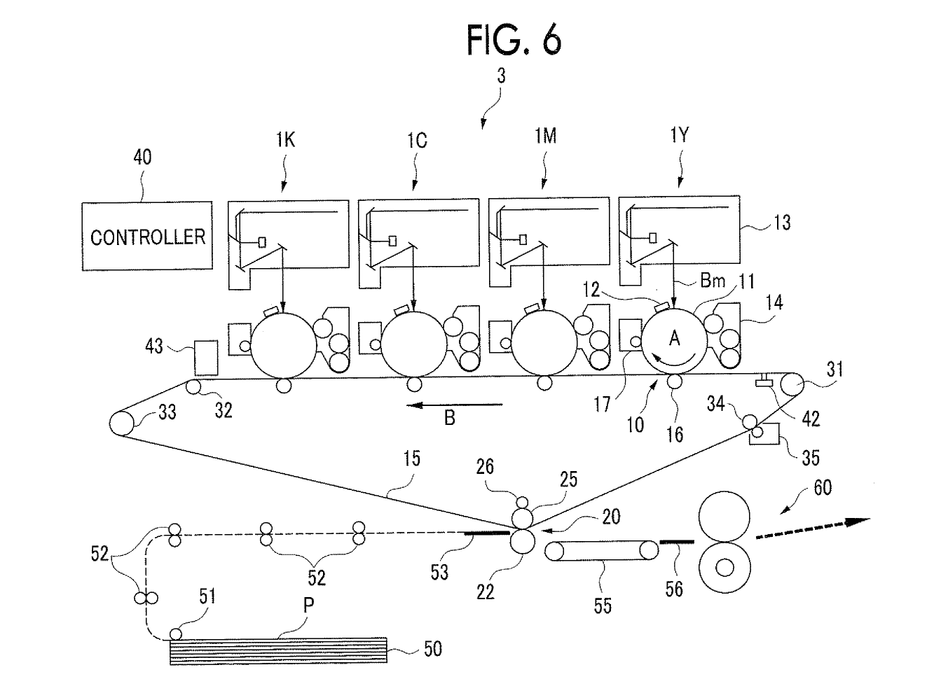

FIG. 6 is a schematic view showing the structure of an image forming apparatus to which the fixing device according to this exemplary embodiment is applied. An image forming apparatus 3 shown in FIG. 6 is an intermediate transfer type image forming apparatus that is generally called a tandem type image forming apparatus. The image forming apparatus 3 includes plural image forming units 1Y, 1M, 1C, and 1K as an example of toner image forming units that form toner images having respective color components by an electrophotographic method; primary transfer sections 10 that sequentially transfer (primarily transfer) the respective color toner images, which are formed by the respective image forming units 1Y, 1M, 1C, and 1K, to an intermediate transfer belt 15; a secondary transfer section 20 that collectively transfers (secondarily transfers) the superimposed toner images, which are transferred to the intermediate transfer belt 15, to a recording medium P such as a recording sheet; and a fixing device 60 as an example of a fixing unit that fixes the secondarily transferred images to the recording medium P. Further, the image forming apparatus 3 includes a controller 40 that controls the operation of each device (each section).

In this exemplary embodiment, each of the image forming units 1Y, 1M, 1C, and 1K includes electrophotographic devices, such as a charger 12, a laser exposure unit 13, a developing section 14, a primary transfer roll 16, and a drum cleaner 17 that are sequentially disposed around a photoreceptor drum 11 as an image supporting body rotating in the direction of an arrow R. The charger 12 as a charging unit that charges the photoreceptor drum 11. The laser exposure unit 13 as an electrostatic latent image forming unit that forms an electrostatic latent image on the photoreceptor drum 11 (in FIG. 6, an exposure beam is denoted by reference character Bm). The developing section 14 as a developing unit that stores each color toner and changes the electrostatic latent image formed on the photoreceptor drum 11 into a visible image by using toner. The primary transfer roll 16 as a primary transfer unit that transfers each color toner image formed on the photoreceptor drum 11 to the intermediate transfer belt 15 at the primary transfer section 10. The drum cleaner 17 as a cleaning unit that removes toner remaining on the photoreceptor drum 11. These image forming units 1Y, 1M, 1C, and 1K are disposed substantially linearly in order of yellow (Y), magenta (M), cyan (C), and black (K) from the upstream side of the intermediate transfer belt 15.

The intermediate transfer belt 15, which is an intermediate transfer body, is formed of a film-shape endless belt that contains an appropriate amount of an antistatic agent such as carbon black in a resin, such as polyimide or polyamide. Further, the intermediate transfer belt 15 is formed so as to have a volume resistivity of 10⁶ Ωcm to 10¹⁴ Ωcm, and the thickness of the intermediate transfer belt 15 is, for example, about 0.1 mm. The intermediate transfer belt 15 is circularly driven (rotationally driven) at a predetermined speed in the direction of an arrow B shown in FIG. 6 by various rolls. These various rolls include a driving roll 31 that is driven by a motor (not shown) having excellent constancy of speed and circularly drives the intermediate transfer belt 15, a support roll 32 that supports the intermediate transfer belt 15 extending substantially linearly in the arrangement direction of the respective photoreceptor drums 11, a tension roll 33 that applies predetermined tension to the intermediate transfer belt 15 and functions as a correcting roll preventing the meandering of the intermediate transfer belt 15, a backup roll 25 that is provided in the secondary transfer section 20, and a cleaning backup roll 34 that is provided in a cleaning unit scraping toner remaining on the intermediate transfer belt 15.

The primary transfer section 10 is formed of the primary transfer roll 16 that is disposed so as to face the photoreceptor drum 11 with the intermediate transfer belt 15 nipped therebetween. The primary transfer roll 16 includes, for example, a shaft and a sponge layer as an elastic layer that is fixed around the shaft. The shaft is a rod that is made of metal, such as iron or SUS, and has a columnar shape or the like. The sponge layer is made of blended rubber or the like of nitrile-butadiene rubber (NBR), styrene-butadiene rubber (SBR), and ethylene-propylene-diene rubber (EPDM) to which a conductive agent such as carbon black is mixed, and is a roll, which has the shape of sponge or the like and a cylindrical shape or the like, of which the volume resistivity is in the range of, for example, 10^{7.5} Ωcm to 10^{8.5} Ωcm. Further, the primary transfer roll 16 is disposed so as to be urged against the photoreceptor drum 11 with the intermediate transfer belt 15 interposed therebetween, and a voltage (primary transfer bias) having a polarity opposite to the polarity of charged toner (referred to as a negative polarity similarly hereinafter) is applied to the primary transfer roll 16. Accordingly, the toner images formed on the respective photoreceptor drums 11 are sequentially and electrostatically attracted to the intermediate transfer belt 15, so that superimposed toner images are formed on the intermediate transfer belt 15.

The secondary transfer section 20 includes a secondary transfer roll 22 that is disposed on the side of the toner image supporting surface of the intermediate transfer belt 15, and the backup roll 25. The surface of the backup roll 25 is formed of a tube that is made of, for example, blended rubber of NBR and EPDM where, for example, carbon is dispersed. The inner portion of the backup roll 25 is made of EPDM rubber. Further, the backup roll 25 is formed so as to have a surface resistivity of, for example, 10⁷Ω/□ to 10¹⁰Ω/□, and the hardness of the backup roll 25 is set to, for example, 70° (ASKER C manufactured by Kobunshi Keiki Co., Ltd., similarly hereinafter). The backup roll 25 is disposed on the back side of the intermediate transfer belt 15 and forms a counter electrode of the secondary transfer roll 22. A power supply roll 26 to which a secondary transfer bias is applied and which is made of metal or the like is disposed so as to come into contact with the backup roll 25.

Meanwhile, the secondary transfer roll 22 includes, for example, a shaft and a sponge layer as an elastic layer that is fixed around the shaft. The shaft is a rod that is made of metal, such as iron or SUS, and has a columnar shape or the like. The sponge layer is made of blended rubber or the like of NBR, SBR, and EPDM to which a conductive agent such as carbon black is mixed, and is a roll, which has the shape of sponge or the like and a cylindrical shape or the like, of which the volume resistivity is in the range of, for example, 10^{7.5} Ωcm to 10^{8.5} Ωcm. Further, the secondary transfer roll 22 is disposed so as to be urged against the backup roll 25 with the intermediate transfer belt 15 interposed therebetween and the secondary transfer roll 22 is grounded, so that a secondary transfer bias is generated between the backup roll 25 and the secondary transfer roll 22. Accordingly, the secondary transfer roll 22 secondarily transfers the toner images to the recording medium P that is transported to the secondary transfer section 20.

Furthermore, an intermediate transfer belt cleaner 35, which removes paper powder, toner, or the like remaining on the intermediate transfer belt 15 having been subjected to secondary transfer to clean the surface of the intermediate transfer belt 15, is provided on the downstream side of the secondary transfer section 20 so as to be freely attached to and detached from the intermediate transfer belt 15. Meanwhile, a reference sensor (home position sensor) 42, which generates a reference signal as the reference used to set an image forming timing of each of the image forming units 1Y, 1M, 1C, and 1K, is provided on the upstream side of the yellow image forming unit 1Y. Further, an image density sensor 43, which adjusts image quality, is provided on the downstream side of the black image forming unit 1K. The reference sensor 42 recognizes a predetermined mark provided on the back of the intermediate transfer belt 15 and generates a reference signal. Each of the image forming units 1Y, 1M, 1C, and 1K starts forming an image according to an instruction that is generated from the controller 40 and based on the recognition of the reference signal.

Moreover, as a sheet transport system, the image forming apparatus 3 according to this exemplary embodiment includes, for example, a sheet tray 50 that accommodates recording media P; a pickup roll 51 that takes and transports the recording medium P stacked in the sheet tray 50 at a predetermined timing; transport rolls 52 that transport the recording medium P taken by the pickup roll 51; a transport shoot 53 that sends the recording medium P, which is transported by the transport rolls 52, to the secondary transfer section 20; a transport belt 55 that transports the recording medium 2, which is transported after being subjected to secondary transfer by the secondary transfer roll 22, to the fixing device 60; and a fixing entry guide 56 that guides the recording medium P to the fixing device 60; and the like.

Next, an example of a basic image forming process of the image forming apparatus according to this exemplary embodiment will be described. In the image forming apparatus shown in FIG. 6, an image forming operation is performed by the image forming units 1Y, 1M, 1C, and 1K after predetermined image processing is performed on image data, which are output from an image reader (IIT) (not shown), a personal computer (PC), or the like, at an image processing device (IPS) (not shown). Predetermined image processing, that is, various kinds of image editing, such as shading correction, positional deviation correction, brightness/color space conversion, gamma correction, edge or color editing, and movement editing, are performed on input reflectance data in the IPS. The image data, which has been subjected to image processing, are converted into gradation data of four color (Y, N, C, and K) materials, and are output to the laser exposure unit 13.

In the laser exposure units 13, the respective photoreceptor drums 11 of the image forming units 1Y, 1M, 1C, and 1K are irradiated with exposure beams Bm emitted from, for example, semiconductor lasers according to the input gradation data of color materials. The surfaces of the respective photoreceptor drums 11 of the image forming units 1Y, 1M, 1C, and 1K are scanned and exposed by the laser exposure units 13 after being charged by the chargers 12. Accordingly, electrostatic latent images are formed on the photoreceptor drums. The formed electrostatic latent images are developed as the respective color (Y, M, C, and K) toner images at the respective image forming units 1Y, 1M, 1C, and 1K.

The toner images, which are formed on the photoreceptor drums 11 of the image forming units 1Y, 1M, 1C, and 1K, are transferred to the intermediate transfer belt 15 at the primary transfer sections 10 where the respective photoreceptor drums 11 come into contact with the intermediate transfer belt 15. More specifically, at the primary transfer sections 10, a voltage (primary transfer bias) having a polarity opposite to the polarity of charged toner (negative polarity) is applied to a base material of the intermediate transfer belt 15 by the primary transfer rolls 16 and the toner images are sequentially superimposed on the surface of the intermediate transfer belt 15, so that primary transfer is performed.

After the toner images are sequentially and primarily transferred to the surface of the intermediate transfer belt 15, the intermediate transfer belt 15 is moved so that the toner images are transported to the secondary transfer section 20. When the toner images are transported to the secondary transfer section 20, the pickup roll 51 is rotated in the sheet transport system at the timing where the toner images are transported to the secondary transfer section 20. Accordingly, a recording medium P having a predetermined size is fed from the sheet tray 50. The recording medium P, which is fed by the pickup roll 51, is transported by the transport rolls 52, and reaches the secondary transfer section 20 via the transport shoot 53. Before reaching the secondary transfer section 20, the recording medium P is stopped and a registration roll (not shown) is rotated at the timing when the intermediate transfer belt 15 on which the toner images are supported is moved. Accordingly, the position of the recording medium P corresponds to the positions of the toner images.

At the secondary transfer section 20, the secondary transfer roll 22 is pressed against the backup roll 25 with the intermediate transfer belt 15 interposed therebetween. In this case, the recording medium P, which is transported at the timing, is interposed between the intermediate transfer belt 15 and the secondary transfer roll 22. At that time, when a voltage (secondary transfer bias) having the same polarity as the polarity of charged toner (negative polarity) is applied to the backup roll from the power supply roll 26, a transfer electric field is formed between the secondary transfer roll 22 and the backup roll 25. Further, the unfixed toner images, which are supported on the intermediate transfer belt 15, are collectively and electrostatically transferred to the recording medium P at the secondary transfer section 20 where the recording medium is pressed by the secondary transfer roll 22 and the backup roll 25.

After that, while being released from the transfer belt 15 by the secondary transfer roll 22, the recording medium P to which the toner images have been electrostatically transferred is transported as it is and is transported to the transport belt 55 provided on the downstream side of the secondary transfer roll 22 in a sheet transport direction. The transport belt 55 transports the recording medium P to the fixing device 60 at an optimal transport speed of the fixing device 60. Fixing processing is performed on the unfixed toner images, which are electrostatically transferred to the recording medium P transported to the fixing device 60, with heat and pressure by the fixing device 60, so that the unfixed toner images are fixed to the recording medium P. Further, the recording medium P on which the fixed images have been formed is transported to an ejected sheet stacking unit (not shown) that is provided at a discharge unit of the image forming apparatus.

Meanwhile, residual toner and the like, which remain on the intermediate transfer belt 15 after the transfer of the images to the recording medium P is completed, are transported to the cleaning unit with the rotational drive of the intermediate transfer belt 15, and is removed from the intermediate transfer belt 15 by the cleaning backup roll 34 and the intermediate transfer belt cleaner 35.

### EXAMPLES

The invention will be more specifically described in detail below with reference to examples. However, the invention is not limited to the following examples.

### Example 1

### Method of Producing Belt

[Production of Electromagnetic Induction Heating Type Fixing Belt]

After a polyimide precursor solution (U-Varnish S manufactured by Ube Industries, Ltd.) is applied to a cylindrical aluminum die, which is processed with a releasing agent (KS700 manufactured by Shin-Etsu Chemical Co., Ltd.) and has a diameter of φ30, by a flow coating device and is dried at a temperature of 120° C. for 30 minutes, a diluted solution containing 10 mass % of silver paste (90 mass % of a silver compound is contained in the paste) and conductive paste (DOTITE XA-9053 manufactured by Fujikura Ltd.) is applied to a semidry polyimide film thereof at a width of 25 μm and a pitch of 1 mm in the axial direction of the belt by a screen printing method.

Then, after being dried at a temperature of 80° C. for 40 minutes, the die is put in a furnace set to 200° C. and silver is baked for 80 minutes, so that two-layer endless belt where a baked film (thickness: 15 μm) made of a conductive paste and formed at a regular interval of 1 mm in the circumferential direction of the belt is formed on a dry polyimide film is obtained (see FIG. 1). In addition, the polyimide precursor solution is applied to the upper surface of the two-layer endless belt, a base layer, a metal heat-generating layer, and a protective layer are simultaneously baked at a temperature of 380° C., and the base layer and the polyimide precursor of the protective layer are cross-linked, so that the protective layer (thickness: 60 μm) made of polyimide is obtained.

Next, a pretreatment primer (DY39-067 manufactured by Dow Corning Toray Silicone Co., Ltd.) of an elastic layer and liquid silicone rubber (X34-1053A/B manufactured by Shin-Etsu Chemical Co., Ltd.) are applied to the outer peripheral surface of a three-layer belt by a flow coating device and the belt is dried at a temperature of 10° C. for 30 minutes, so that an elastic layer having a thickness of 200 μm is formed. After that, tubing covering of a PFA tube (tetrafluoroethylene perfluoroalkyl vinyl ether copolymer tube), which has a thickness of 30 μm, as a release layer is performed on the outer peripheral surface of the elastic layer by a covering machine, and the PEA tube is put in a furnace of 200° C. and is vulcanized and baked, so that a release layer is formed. A fixing belt is produced by the method described above.

### Example 2

A conductive layer pattern where resin portions are scattered over the entire surface of a belt is formed (see FIG. 3) in the same manner as Example 1 except that temperature is raised up to 200° C. at a rate of 10° C./min and silver is baked at a temperature of 200° C. for 80 minutes after silver paste is applied to the entire outer peripheral surface of the semidry polyimide film with a flow coating method in Example 1 and is dried at a temperature of 80° C. for 40 minutes. The interval of the resin portions in the circumferential direction is 0.2 and the interval of the resin portions in the axial direction is 0.2 mm. A fixing belt is produced in the same manner as Example 1 except for this.

### Example 3

A fixing belt is produced in the same manner as Example 1 except that a conductive layer pattern is formed at a pitch of 7 mm in the circumferential direction of the belt.

### Example 4

A fixing belt is produced in the same manner as Example 1 except that a conductive layer pattern is formed at a pitch of 8 mm in the circumferential direction of the belt.

### Comparative Example 1

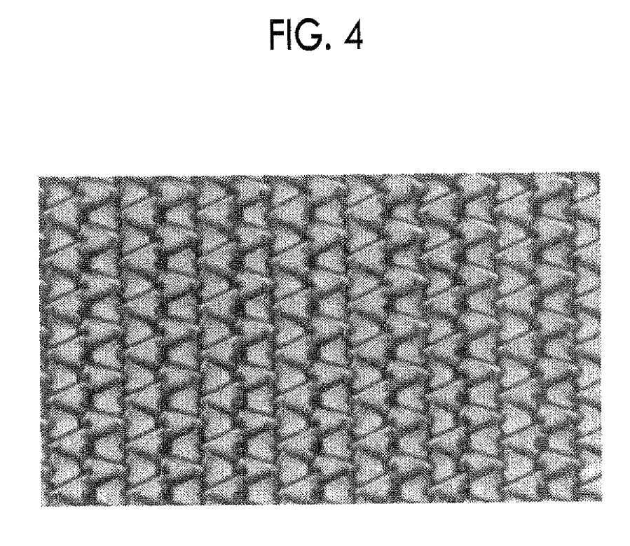

A metal heat-generating layer having a three-dimensional mesh structure is formed with a SUS material by a method of knitting metal wires in a cylindrical shape. FIG. 4 is a view showing an image of the structure of a metal heat-generating layer of Comparative Example 1. A fixing belt is produced in the same manner as Example 1 except for this.

### Comparative Example 2

A metal heat-generating layer having a two-dimensional mesh structure is formed with a SUS material by a method of knitting metal wires in a cylindrical shape. A fixing belt is produced in the same manner as Example 1 except for this.

### Comparative Example 3

As in Example 1, after a polyimide precursor solution (U-Varnish S manufactured by Ube Industries, Ltd.) is applied to a cylindrical die, which is processed with a releasing agent, by a flow coating device and is dried at a temperature of 100° C. for 30 minutes, the die is put in a furnace of 380° C. and baking is performed for 60 minutes, so that a base layer having a thickness of 60 μm is formed. Next, roughening is performed on the outer peripheral surface of the base layer as the pretreatment of a base metal layer by a blasting device. Specifically, roughening is performed so that the surface roughness Ra of the middle portion (within a sheet feeding width) of the base layer in the axial direction of the belt is 0.5 μm. Next, an electroless nickel layer is formed on the outer peripheral surface of the base layer as a base metal layer. Specifically, the base metal layer is formed on condition that the thickness of the base metal layer at the middle portion in the axial direction of the belt is 0.5 μm. Next, on the outer peripheral surface of the base metal layer, an electrolytic copper plating layer having a thickness of 10 μm is formed as a metal heat-generating layer and an electrolytic nickel plating layer having a thickness of 10 μm is formed as a metal protective layer. Specifically, while the base metal layer, which is formed on the outer peripheral surface of the base layer, is used as a negative electrode, power supply units are disposed at both end portions that are positioned outside the width of the middle portion in the axial direction of the belt and electrolytic plating is performed, so that the metal heat-generating layer and the metal protective layer are formed. A fixing belt is produced in the same manner as Example 1 except for this.

<Evaluation>

(Durability of Belt)

The obtained belt is provided in a fixing unit of an image forming apparatus (DocuCentreIVC3370) manufactured by Fuji Xerox Co., Ltd.; and the temperature rise performance and durability of the belt are evaluated by the examination of the time (warm-up time) taken until the temperature of the belt is raised up to a desired temperature and the number of rotations (corresponding to the number of printed sheets and denoted by PV hereinafter) until cracks are formed at the belt. A nip width is set to 7 mm. Results are shown in Table 1. The durability of the belt is evaluated until the number of rotations corresponds to 1000 kPV for each of a case when the radius of curvature R of a nip outlet is 5.5 and a case when the radius of curvature R of a nip outlet is 5. A case when there is no crack is denoted by “no crack”. The durability of the belt is evaluated on the basis of the following.

◯: 1000 kPV or more

Δ: 500 kPV or more

X: less than 500 kPV

(Warm-Up Time)

Warm-up time (WUT) is defined as the time taken until the temperature of a surface of a fixing member reaches 160° C. after heating starts to be performed with 1100W.

◯: shorter than 10 seconds

Δ: equal to or longer than 10 seconds and shorter than 20 seconds

X: 20 seconds or more

TABLE 1

| | | | | | | | Comparative | Comparative | Comparative |
|---|---|---|---|---|---|---|---|---|---|
| | | | Example 1 | Example 2 | Example 3 | Example 4 | Example 1 | Example 2 | Example 3 |
| Structure of heat-generating layer | | | Circumferential | Through | Circumferential | Circumferential | Three- | Two- | Single layer |
| | | | division type | openings | division type | division type | dimensional | dimensional | |
| | | | | scattering | | | mesh | mesh | |
| | | | | type | | | | | |
| Circumferential pitch [mm] | | | 1 | 0.2-0.5 | 7 | 8 | — | — | — |
| Durability | Number of | R = 5.5 | 1000 kPV | 1000 kPV | 1000 kPV | 900 kPV | 800 kPV | 100 kPV | 800 kPV |
| | rotations at | | No crack | No crack | No crack | | | | |
| | the time of | R = 5 | 1000 kPV | 1000 kPV | 1000 kPV | 600 kPV | 100 kPV | 10 kPV | 500 kPV |
| | generation of | | No crack | No crack | No crack | | | | |
| | cracks/ | | | | | | | | |
| | permanent | | | | | | | | |
| | deformation | | | | | | | | |
| | (corresponding | | | | | | | | |
| | to PV) | | | | | | | | |

| | | | | | | | | |
|---|---|---|---|---|---|---|---|---|
| | Judgment | ◯ | ◯ | ◯ | Δ | Δ | X | Δ |
| Temperature | Warm-up time | 3 sec | 3 sec | 3 sec | 3 sec | 20 sec | 15 sec | 3 sec |
| rise | Judgment | ◯ | ◯ | ◯ | ◯ | X | Δ | ◯ |
| performance | | | | | | | | |

As described above, the fixing belt of the Examples, in which the metal heat-generating layer contains the resin portions that pass through the metal heat-generating layer in the thickness direction, and the protective layer fills the opening portions, has short warm-up time and high durability as compared to the fixing belt of Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing belt comprising:
a base layer that contains a resin;
a flat metal heat-generating layer that is provided on the base layer and contains metal as a main component; and
a protective layer that is provided on the metal heat-generating layer and contains a resin,
wherein the metal heat-generating layer contains resin portions that pass through the metal heat-generating layer in a thickness direction of the layer, and
the resin portions contain at least one of the resin of the base layer and the resin of the protective layer.

2. The fixing belt according to claim 1,
wherein the resin portions are positioned at regular intervals in a circumferential direction of the belt over a width direction of the belt.

3. The fixing belt according to claim 1,
wherein the resin portions are scattered on the surface of the belt.

4. The fixing belt according to claim 1,
wherein the metal heat-generating layer contains silver.

5. The fixing belt according to claim 2,
wherein the regular interval of the resin portions is in the range of 0.1 mm to 10 mm.

6. The fixing belt according to claim 2,
wherein the width of the resin portion in the circumferential direction of the belt is in the range of 1 μm to 1000 μm.

7. The fixing belt according to claim 2,
wherein the shape of the resin portion is a straight shape or a curved shape.

8. The fixing belt according to claim 1,
wherein the thickness of the metal heat-generating layer is in the range of 3 m to 30 μm.

9. A method of manufacturing a fixing belt comprising:
forming a metal heat-generating layer on a base layer;
forming a protective layer on the metal heat-generating layer; and
baking the base layer, the metal heat-generating layer, and the protective layer simultaneously,
wherein the metal heat-generating layer contains resin portions that pass through the metal heat-generating layer in a thickness direction of the layer, and
the resin portions contain at least one of the resin of the base layer and the resin of the protective layer.

10. The method according to claim 9,
wherein the resin portions are formed at regular intervals in a circumferential direction of the belt over a width direction of the belt.

11. The method according to claim 9,
wherein the resin portions are scattered on the surface of the belt.

12. The method according to claim 9,
wherein the metal heat-generating layer contains silver.

13. A fixing device comprising:
the fixing belt according to claim 1.

14. The fixing device according to claim 13,
wherein the resin portions of the fixing belt are positioned at regular intervals in a circumferential direction of the belt over a width direction of the belt.

15. The fixing device according to claim 13,
wherein the resin portions of the fixing belt are scattered on the surface of the belt.

16. The fixing device according to claim 13,
wherein the metal heat-generating layer of the fixing belt contains silver.

17. An image forming apparatus comprising:
a toner image forming unit that forms unfixed toner images on a recording medium, and
the fixing device according to claim 13.

18. An image forming apparatus comprising:
a toner image forming unit that forms unfixed toner images on a recording medium, and
the fixing device according to claim 14.

19. An image forming apparatus comprising:
a toner image forming unit that forms unfixed toner images on a recording medium, and
the fixing device according to claim 15.
